(19) United States
(12) Patent Application Publication
(10) Pub. No.: US 2009/0244885 A1
(43) Pub. Date: Oct. 1, 2009

(54) REFLECTOR FRAME, FLAT LIGHT SOURCE DEVICE PROVIDED WITH THE REFLECTOR FRAME, AND DISPLAY DEVICE USING THE FLAT LIGHT SOURCE DEVICE

(75) Inventors: Takeo Watanabe, Chiba (JP); Shuichi Naijo, Chiba (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Minato-ku, Tokyo (JP)

(21) Appl. No.: 12/095,092

(22) PCT Filed: Nov. 27, 2006
(86) PCT No.: PCT/JP2006/324126

§ 371 Date: May 27, 2008

Related U.S. Application Data
(60) Provisional application No. 60/748,212, filed on Dec. 8, 2005.

(30) Foreign Application Priority Data
Nov. 29, 2005 (JP) 2005-343513

(51) Int. Cl. G02F 1/13357; F21S 4/00; F21V 9/00; H01J 9/24

(52) U.S. Cl. 362/97.1; 362/249.01; 362/231; 362/249.02; 445/24

(57) ABSTRACT

A reflector frame, which is disposed on a light-emitting device mounting substrate on which a plurality of light-emitting devices is disposed in an array pattern, is characterized by comprising a plurality of opening portions corresponding to the disposed positions of the light-emitting devices.

### CROSS REFERENCES TO RELATED APPLICATIONS

This application is an application filed under 35 U.S.C. §111(a) claiming benefit pursuant to 35 U.S.C. §119(e) (1) of the filing date of Provisional Application 60/748,212 filed on Dec. 8, 2005 pursuant to 35 U.S.C. §111(b).

### TECHNICAL FIELD

The present invention relates to a reflector frame, a flat light source device provided with the reflector frame, and a display device using the flat light source device that increase a luminance of a light-emitting device in substance in the case in which the light-emitting device is used as a light source of an illumination and a back light for a liquid crystal display device.

### BACKGROUND ART

In recent years, there is widely used a display device using the flat light source device (back light) for incident a light from the back or side face of a panel, such as a liquid crystal display. Conventionally, the main stream of such a back light source for a liquid crystal display has been the so-called edge light type in which a cold cathode tube as a light source is disposed on the edge face of the chassis for thinning and low power consumption of the apparatus.

As such a back light source of the edge light type, a light source with a configuration shown in FIG. 9 is used.

More specifically, for a back light source 100 of the edge light type, a cold cathode tube 104 is disposed on the edge portion of a chassis 102. A light guide plate 106 is disposed on the side of the cold cathode tube 104, and a diffusing sheet 108 is disposed on the upper face of the light guide plate 106, thereby configuring the back light source 100.

A reflecting layer 116, which is made by a minute uneven structure or made by drawing a dot shape with a white ink for instance, is formed under the light guide plate 106.

Moreover, a liquid crystal panel 110 is disposed on the upper face of the diffusing sheet 108 of the back light source 100, thereby configuring a liquid crystal display device 112.

For the back light source 100 of the edge light type, a light that has been emitted from the cold cathode tube 104 enters a side portion 114 of the light guide plate 106.

A light that has entered the light guide plate 106 is diffused while repeating a reflection between the reflecting layer 116 that has been formed under the light guide plate 106 and that is made by a minute uneven structure or made by drawing a dot shape with a white ink for instance, and an upper face 118 of the light guide plate 106. The light is then uniformly guided upward from the upper face 118 of the light guide plate 106.

By the above configuration, a light is uniformly diffused by the diffusing sheet 108, thereby reducing a nonuniformity in luminance of the liquid crystal panel 110.

However, a demand of enlarging a liquid crystal display has been increased in recent years, and such a back light source 100 of the edge light type has a limitation in improving a luminance and a uniformity in the luminance.

Therefore, an adoption of a direct lighting type light is examined for a large size liquid crystal display.

However, in the case in which the above described cold cathode tube is used as a direct lighting type light, since the cold cathode tube is comparatively large, a thickness of a liquid crystal display is enlarged. In addition, there are problems that gamut of reproducible colors and a response of the cold cathode tube is not satisfactory, and that an after-image phenomenon occurs.

On the other hand, in recent years, a light emission efficiency of a light-emitting device has been extremely improved, and an application of a solid-state light-emitting device to an illumination is being progressed. Consequently, among such solid-state light-emitting devices, it has been examined to use a light emitting diode (LED) in particular as a back light source (flat light source) for a liquid crystal display.

In the case in which a light emitting diode is used as a back light source for a liquid crystal display as described above, a demand of enlarging a display screen can be satisfied, the satisfactory gamut of reproducible colors and a high speed response can be implemented, and it is expected that a high quality display be achieved.

Therefore, there is proposed a back light source of a direct lighting type in which a plurality of LEDs is disposed at a specified pitch below a liquid crystal panel.

As such a back light source of a direct lighting type, a light source with a configuration shown in FIG. 10 is proposed.

More specifically, a back light source 200 of the direct lighting type is provided with an LED substrate (mounting substrate) as a substrate (not shown) in which a plurality of light emitting diodes 206 is arranged in series as a light source on the bottom face 204 of a chassis 202. In FIG. 10, only a line of light emitting diodes 206 is shown. However, a plurality of the lines is disposed in parallel at a specified pitch in an array pattern on the bottom face 204.

A diffusing sheet 208 is disposed on the upper face of the chassis 202 apart from the light emitting diodes 206, and a prism sheet 210 is disposed on the upper face of the diffusing sheet 208, thereby configuring the back light source 200.

A reflecting layer 214 made of a reflecting sheet or the like is formed on the bottom face 204 and a side face 212 of the chassis 202.

For the back light source 200 of a direct lighting type that is configured as described above, in the case in which a light is generated from the light emitting diode 206, the light emitted from the light emitting diode 206 travels directly toward the diffusing sheet 208. In addition, the emitted light is also reflected by the reflecting layer 214 on the bottom face 204 and the side face 212 of the chassis 202, and travels toward the diffusing sheet 208.

The light that has entered the diffusing sheet 208 is then irregularly reflected in the diffusing sheet 208, and is inclined in a vertical direction by passing through the prism sheet 210 on the upper face of the diffusing sheet 208. The light then enters a liquid crystal panel (not shown) disposed on the upper face of the prism sheet 210.

Moreover, lights emitted from the light emitting diodes 206 are mixed in a space between the light emitting diodes and the diffusing sheet 208. The mixing is then improved by an irregular reflection in the diffusing sheet 208, thereby implementing a uniformity in luminance and a chromaticity.

In the case in which a light emitting diode is used for the back light source 200 of a direct lighting type, there is suitably used an LED lamp of the so-called three-in one package, in which light emitting diode (LED) chips that emit lights of red, green, and blue which are three primary colors of lights are installed in one package and a white color is generated by mixing these colors (for instance, see Non Patent Document 1 (the website of STANLEY ELECTRIC CO., LTD.)).

As shown in FIGS. 11(a) and 11(b), for such a three-in one package 300, an LED chip 302 emitting a red light, an LED chip 304 emitting a green light, and an LED chip 306 emitting a blue light each of approximately 0.35 mm square are adjacently disposed at the positions corresponding to vertexes of an almost equilateral triangle, respectively, at the center of a light-emitting device mounting substrate 310 with an outline of several mm square in an almost rectangular shape.

Moreover, a reflector frame 308, which is provided with an inclined opening portion 312 formed in such a manner that an opening edge is thinner, is disposed on the peripheral area of the LED chips 302, 304, and 306.

For such a three-in one package 300, lights of three colors generated from the LED chips 302, 304, and 306 are reflected at the inclined side wall of the opening portion 312 of the reflector frame 308, and the three colors are mixed, thereby easily obtaining a white color light.

As described above, since such a three-in one package 300 is conventionally provided with the reflector frame 308 for reflecting and mixing lights of three colors generated from the LED chips 302, 304, and 306, a white color light can be effectively obtained.

FIG. 12 shows a conventional luminous display device 400 in which a reflecting material 404 is disposed on the inside face of a reflector frame 402 in such a manner that a light to be reflected by the reflector frame 402 can be further effectively reflected (see Patent Document 1: Japanese Laid-Open Patent Publication No. 2001-168396).

In the case in which a reflecting material 404 is not disposed on the inside face of a reflector frame 402, a light emitted from each LED lamp 406 is slightly absorbed in the inside face of the reflector frame 402.

However, according to the luminous display device 400, since the reflecting material 404 covers the inside face of a reflector frame 402, a light irradiated from each LED lamp 406 can be effectively reflected by the reflecting material 404, and a light emitted from the LED lamp 406 can be effectively utilized without an attenuation.

Consequently, according to the luminous display device 400 shown in FIG. 12, even in the case in which an LED that emits a light of a small amount is used, a vivid image can be obtained by improving a contrast.

In general, such a reflector frame 402 is disposed one by one corresponding to each three-in one package configured by LED lamps of three colors.

In the case in which an LED lamp is used as a large back light source such as a liquid crystal display, many three-in one packages provided with a reflector frame 402 in an integrated manner are provided, and the many three-in one packages are arranged and disposed in an array pattern on a light-emitting device mounting substrate, thereby forming a back light source.

[Non Patent Document 1] The website of STANLEY ELECTRIC CO., LTD., [online], internet <http://www.stanley-components.com>

### [Patent Document 1] Japanese Laid-Open Patent Publication No. 2001-168396

### DISCLOSURE OF THE INVENTION

### Problems to be Solved by the Invention

However, in the case in which the method, in which a plurality of packages provided with such light emitting diodes is fabricated in advance and the packages are arranged and disposed on a light-emitting device mounting substrate, is applied to a large flat light source device such as a liquid crystal display, the number of parts and the man-hours of work operations are increased, thereby increasing a production cost.

In order to solve the above problems, it is thought that a flat light source device is configured by only disposing a plurality of light emitting diodes of three kinds linearly in series without using a reflector frame. However, in the case in which a reflector frame is not used, just an amount of a light emission of a light emitting diode that emits a light of a small amount is depended, and an amount of a light emission of only a light emitting diode is not enough to improve a contrast of a flat light source device.

The present invention was made in consideration of such conditions, and an object of the present invention is to provide a reflector frame, a flat light source device provided with the reflector frame, and a display device using the flat light source device that are capable of being easily applied to a large flat light source device with a production cost suppressed and of improving a contrast even in the case in which a light-emitting device that emits a light of a small amount is used.

### Means for Solving the Problems

The present inventors have researched the above problems to solve them. As a result, the present inventors have created the reflector frame and the flat light source device provided with the reflector frame related to the present invention.

More specifically, the present invention involves the following modes (1) to (15) for instance.

(1)

A reflector frame, which is disposed on a light-emitting device mounting substrate on which a plurality of light-emitting devices is disposed in an array pattern, is characterized by comprising a plurality of opening portions corresponding to the disposed positions of the light-emitting devices.

(2)

A reflector frame as defined in above (1) is characterized in that a plurality of the light-emitting devices with different luminescent colors is disposed in the opening portion.

(3)

A reflector frame as defined in above (2) is characterized in that the light-emitting devices with different luminescent colors are configured by a combination of at least one light-emitting device with a luminescent color of red, at least one light-emitting device with green, and at least one light-emitting device with blue.

(4)

A reflector frame as defined in above (1) is characterized in that a light-emitting device with a luminescent color of white is disposed in the opening portion.

(5)

A reflector frame as defined in any one of above (1) to (4) is characterized in that the opening portion is in an almost circular or rectangular shape.

(6)

A reflector frame as defined in any one of above (1) to (5) is characterized by further comprising a reflecting face that spreads and opens toward the outside in the opening portion.

(7)

A reflector frame as defined in any one of claims (1) to (6) is characterized in that the light-emitting device is a light emitting diode (LED) lamp.

(8)

A reflector frame as defined in above (7) is characterized in that the light emitting diode (LED) is a light emitting diode (LED) chip.

(9)

A flat light source device is characterized by comprising a reflector frame as defined in any one of above (1) to (8) on the upper face of the light-emitting device mounting substrate on which a plurality of the light-emitting devices is disposed in an array pattern.

(10)

A flat light source device as defined in above (9) is characterized by further comprising a transparent sealing resin buried in the opening portion of the reflector frame.

(11)

A flat light source device as defined in above (9) or (10) is characterized in that the flat light source device is a back light for a display device.

(12)

A display device is characterized in that a liquid crystal panel is disposed on the upper face of the flat light source device as defined in any one of above (9) to (11).

(13)

A manufacturing method of a flat light source device is characterized by comprising the steps of:

disposing a plurality of light-emitting devices in an array pattern on a light-emitting device mounting substrate,

preparing a reflector frame provided with a plurality of opening portions corresponding to the disposed positions of the light-emitting devices, and

disposing the reflector frame at the disposed position corresponding to the light-emitting device s on the light-emitting device mounting substrate.

(14)

A manufacturing method of a flat light source device as defined in above (13) is characterized by further comprising the step of burying a transparent sealing resin in the opening portion of the reflector frame.

(15)

A manufacturing method of a display device is characterized by comprising the steps of:

preparing the flat light source device obtained by the manufacturing method as defined in above (13) or (14), and

disposing a liquid crystal panel on the upper face of the flat light source device.

### EFFECT OF THE INVENTION

According to a reflector frame, a flat light source device provided with the reflector frame, and a display device using the flat light source device related to the present invention, the number of parts and the man-hours of work operations are reduced, thereby easily fabricating a large flat light source device at a low production cost. In addition, a vivid image can be obtained by improving a contrast even in the case in which a light-emitting device that emits a light of a small amount is used.

### BRIEF DESCRIPTION OF THE DRAWINGS

FIG. 1 is a view showing an entire configuration of a liquid crystal display device to which the present embodiment is applied.

FIG. 2 is a schematic view showing a configuration in which LED lamps are disposed in advance on a light-emitting device mounting substrate to which a reflector frame related to an embodiment according to the present invention will be disposed. FIG. 2(a) is a top face view showing a configuration in which LED lamps of three colors are installed on a light-emitting device mounting substrate, and FIG. 2(b) is a cross-sectional view showing a configuration along the X-X line shown in FIG. 2(a).

FIG. 3 is a schematic view showing a flat light source device in which a reflector frame related to an embodiment according to the present invention is disposed. FIG. 3(a) is a top face view, and FIG. 3(b) is a disassembled cross-sectional view showing a configuration along the X-X line shown in FIG. 3(a).

FIG. 4 is a schematic view showing a flat light source device in which a reflector frame related to an embodiment according to the present invention is disposed. FIG. 4(a) is a top face view, and FIG. 4(b) is an assembled cross-sectional view showing a configuration along the X-X line shown in FIG. 4(a).

FIG. 5 is a schematic view showing a flat light source device in which a reflector frame related to another embodiment according to the present invention is disposed. FIG. 5(a) is a top face view, and FIG. 5(b) is an assembled cross-sectional view showing a configuration along the X-X line shown in FIG. 5(a).

FIG. 6 is a schematic view showing a flat light source device in which a reflector frame related to another embodiment according to the present invention is disposed. FIG. 6(a) is a top face view, and FIG. 6(b) is an assembled cross-sectional view showing a configuration along the X-X line shown in FIG. 6(a).

FIG. 7 is a schematic view showing a flat light source device in which a reflector frame related to another embodiment according to the present invention is disposed. FIG. 7(a) is a top face view, and FIG. 7(b) is an assembled cross-sectional view showing a configuration along the X-X line shown in FIG. 7(a).

FIG. 8 is a schematic view showing a light-emitting device adopted in another embodiment according to the present invention.

FIG. 9 is a schematic cross-sectional view showing a conventional back light source of an edge light type.

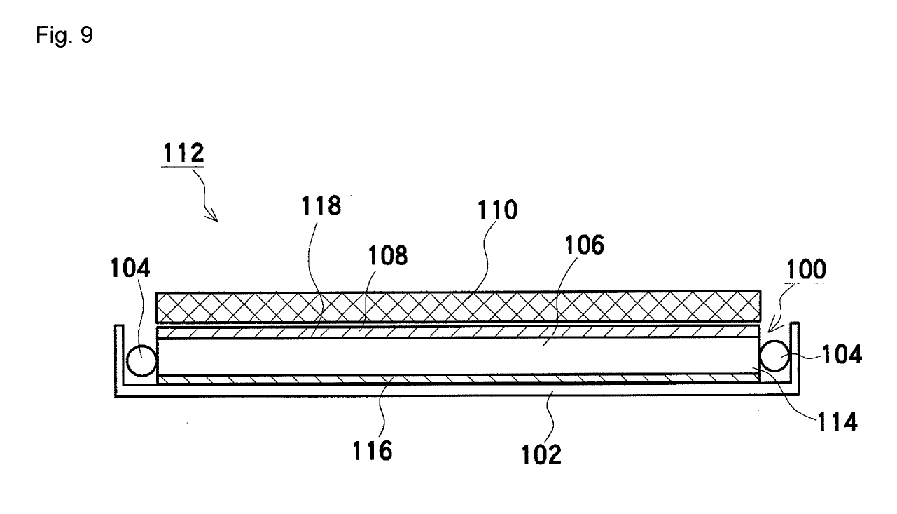

FIG. 10 is a schematic cross-sectional view showing a conventional back light source of a direct lighting type.

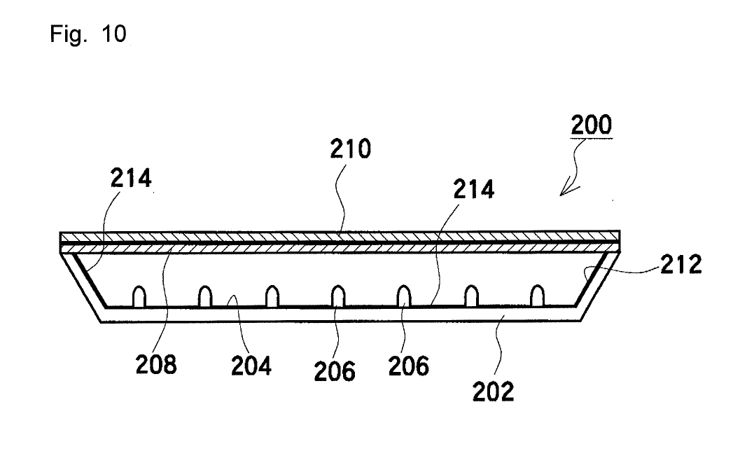

FIG. 11 is a schematic view showing a conventional three-in one package. FIG. 11(a) is a plan view, and FIG. 11(b) is an assembled cross-sectional view showing a configuration along the X-X line shown in FIG. 11(a).

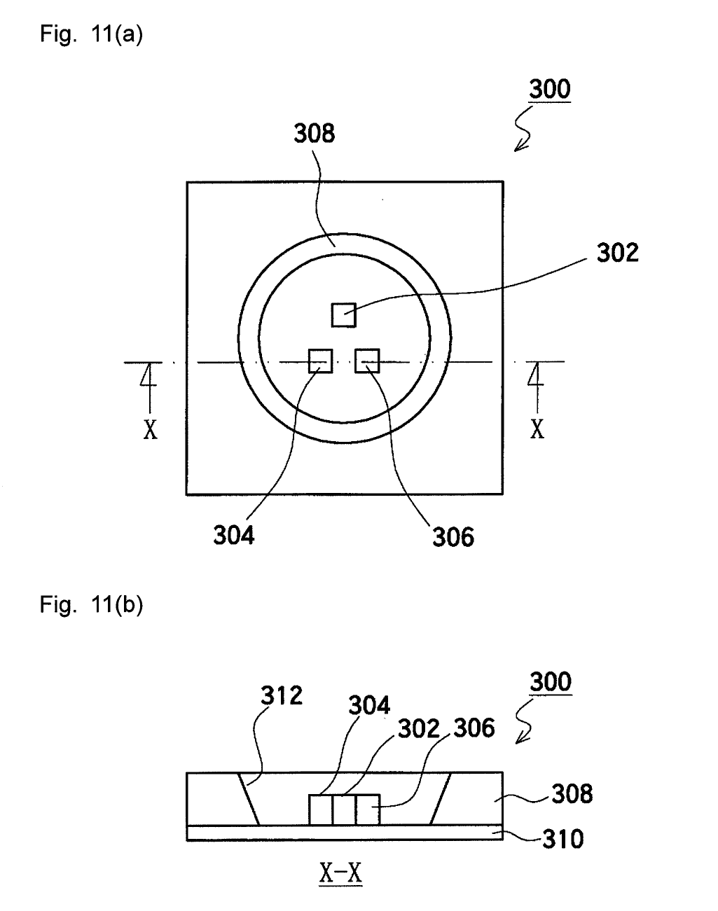

FIG. 12 a schematic cross-sectional view showing a conventional luminous display device in which a reflecting material is disposed on the inside face of a reflector frame.

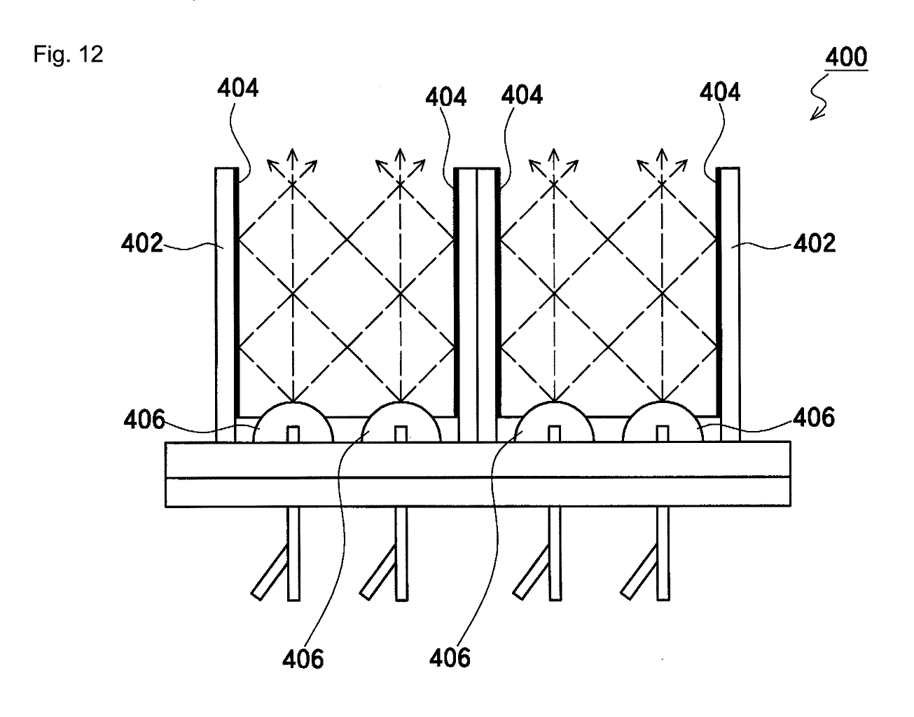

### BEST MODE OF CARRYING OUT THE INVENTION

The embodiments of the present invention will be described below in detail with reference to the drawings. The present invention is not restricted to the following embodiments.

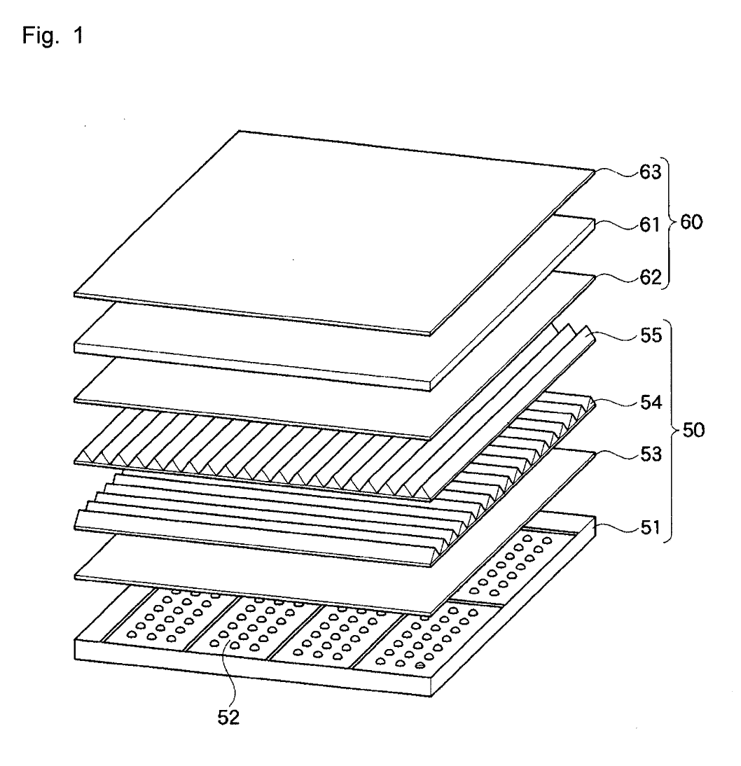

FIG. 1 is a view showing an entire configuration of a typical liquid crystal display device to which the present embodiment is applied.

A liquid crystal display device to which the present embodiment is applied is provided with as a back light apparatus (back light) 50 of a direct lighting type which comprises a back light frame 51 enclosing a luminous portion and an LED substrate (light-emitting device mounting substrate) 52 as a substrate on which a plurality of light emitting diodes (LEDs) that are solid-state light-emitting devices is arranged as a light source.

A reflector frame related to the present invention is disposed on the LED substrate 52. The back light apparatus 50 is provided with a diffusing member (plate or sheet) 53 for scattering or diffusing lights in order to implement the uniform brightness of the entire face and prism sheets 54 and 55 having a forward condensing effect as a laminate of an optical compensating sheet.

Moreover, a liquid crystal display module 60 is provided with a liquid crystal panel 61 in which a liquid crystal is interposed by two glass substrates and polarizing plates (polarizing filters) 62 and 63 laminated on each of the glass substrates of the liquid crystal panel 61 for restricting a light wave vibration to a certain direction.

Furthermore, the liquid crystal display device is provided with peripheral members such as a driving LSI although this is not shown in the figure.

The liquid crystal panel 61 contains many kinds of components although these are not shown in the figure. For instance, the liquid crystal panel is provided with two glass substrates, a display electrode, an active device such as a thin film transistor, a liquid crystal, a spacer, a sealing agent, an orientation film, a common electrode, a protection film, and a color filter although these are not shown in the figure.

Moreover, any configuration unit of the back light apparatus 50 can be selected. For instance, only a unit of the back light frame 51 provided with the LED substrate 52 can be called as a back light apparatus (back light), and there can be implemented a flow-through type that does not contain a laminate of an optical compensating sheet such as the diffusing member (plate or sheet) 53 and the prism sheets 54 and 55.

The back light frame 51 has a chassis structure made of a material such as aluminum, magnesium, iron, or a metal alloy thereof. Moreover, a white polyester film having a performance of a high reflection and so on is bonded to the inside face of the chassis structure, thereby involving a function as a reflector.

The chassis structure is provided with a back face portion formed corresponding to the size of the liquid crystal display module 60 and a side face portion surrounding the four edges of the back face portion. If necessary, a heat sink configuration such as a cooling fin for dissipating heat is formed in the back face portion or the side face portion in some cases.

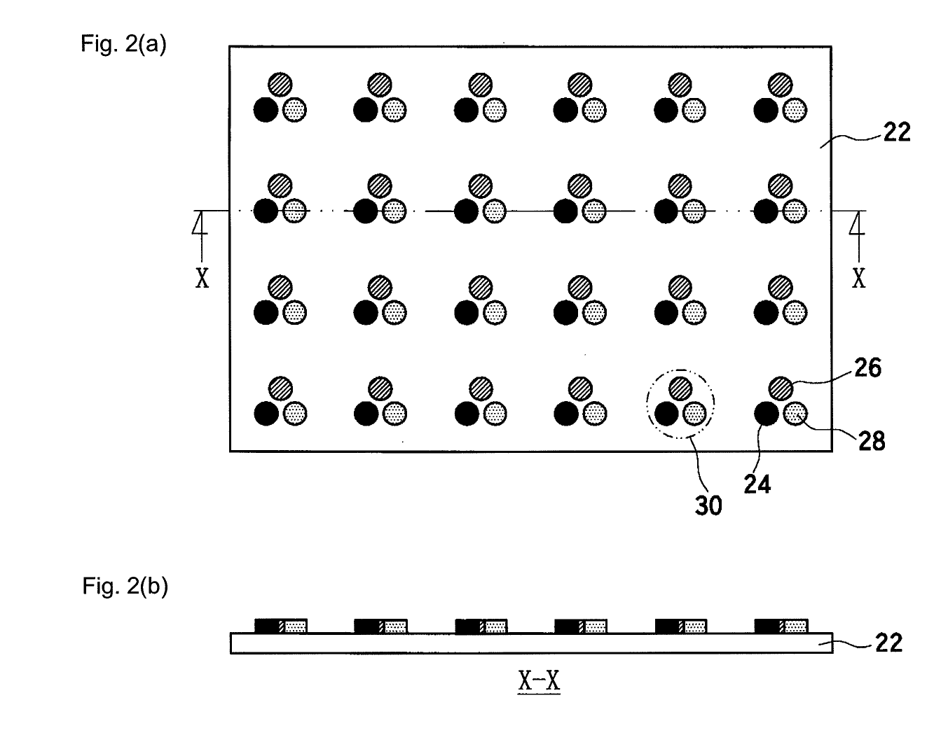

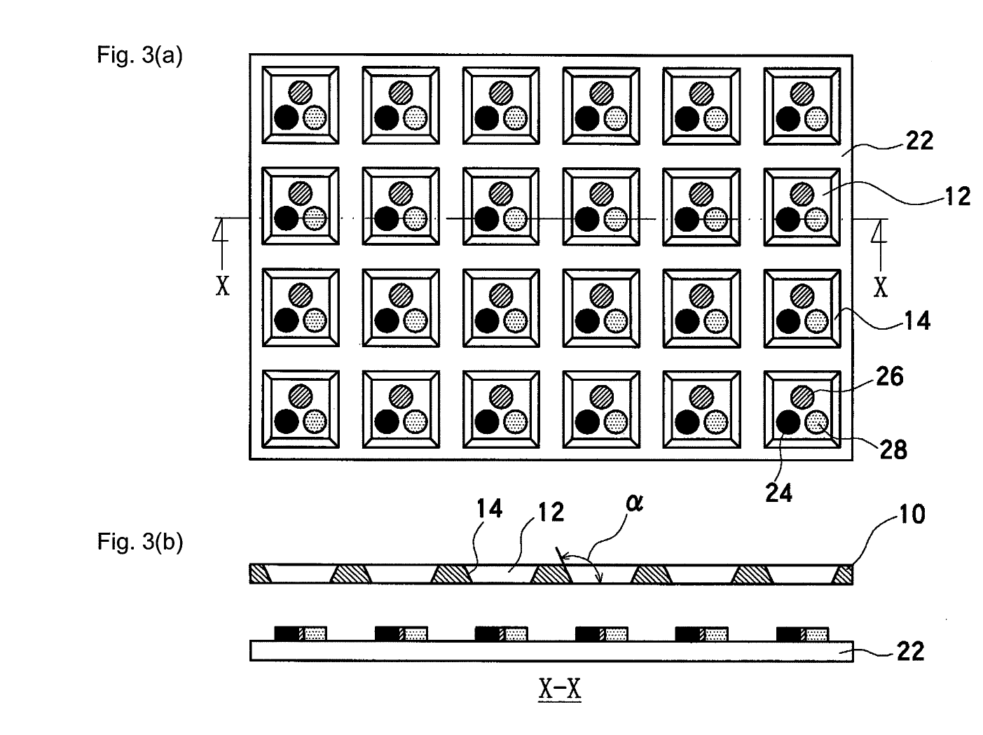

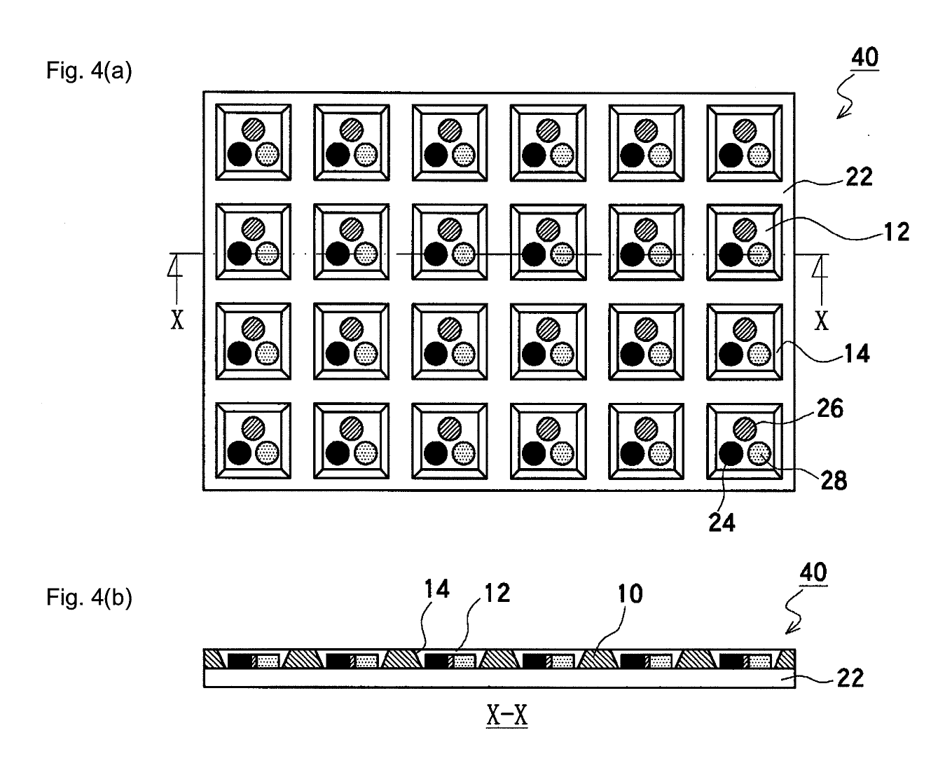

FIG. 2(a) is a top face view showing a configuration in which LED lamps of three colors are installed on a light-emitting device mounting substrate for instance, and FIG. 2(b) is a cross-sectional view showing a configuration along the X-X line shown in FIG. 2(a). FIG. 3(a) is a top face view showing a flat light source device in which a reflector frame related to an embodiment according to the present invention is disposed, and FIG. 3(b) is a disassembled cross-sectional view showing a configuration along the X-X line shown in FIG. 3(a). FIG. 4(a) is a top face view showing a flat light source device in which a reflector frame related to an embodiment according to the present invention is disposed, and FIG. 4(b) is an assembled cross-sectional view showing a configuration along the X-X line shown in FIG. 4(a).

A flat light source device provided with a reflector frame related to the present embodiment is used as a light source of an illumination and a back light for a liquid crystal display device for instance. In the present embodiment, a white color can be obtained by using LED lamps of three different colors.

As shown in FIG. 2, a plurality of LED chips emitting a red light 24, a plurality of LED chips emitting a green light 26, and a plurality of LED chips emitting a blue light 28 are disposed on a light-emitting device mounting substrate 22 in the present embodiment. While the LED chips 24, 26, and 28 with different colors can be separately formed and disposed, it is preferable to configure an LED assembly 30 as one unit in advance and arrange the LED assembly 30 on the light-emitting device mounting substrate 22. According to the above configuration, the man-hours of work operations can be reduced and a white color can be uniformed.

Moreover, the electrode pads (not shown) of the light-emitting device mounting substrate 22 and the electrodes (not shown) of the LED chips 24, 26, and 28 are connected to each other by wire bonding with a gold wire.

While the size of the light-emitting device mounting substrate 22 on which many LED assemblies 30 are installed can be equivalent to that of a divided portion of a display section of a display device such as a liquid crystal display, the size of the light-emitting device mounting substrate is preferably almost equivalent to that of the display section.

On the other hand, as shown in FIGS. 3(a) and 3(b), a reflector frame 10 disposed on the light-emitting device mounting substrate 22 has a size almost equivalent to that of the light-emitting device mounting substrate 22. However, it is not necessary that the reflector frame 10 has a size equivalent to that of the light-emitting device mounting substrate 22. In the case in which the light-emitting device mounting substrate 22 is composed of divided members, the reflector frame 10 is preferably integer times as large as the divided member. The reflector frame 10 related to the present embodiment has a size equivalent to that of the entire display section of the display device, and the light-emitting device mounting substrate 22 is also formed as large as the entire display section.

In such a reflector frame 10 composed of one member, a plurality of opening portions 12 is formed at a specified pitch in advance at positions corresponding to the LED assemblies 30.

A material of such a reflector frame 10 is not restricted in particular. For instance, the reflector frame 10 can be formed by molding a thermoplastic resin such as an acrylic resin, a polycarbonate, a liquid crystal polymer, and a polyamide resin, or a thermosetting resin such as an epoxy resin in a desired shape of the reflector frame 10 and by coating a metal film with a satisfactory reflectance such as aluminum or silver on the surface or by coating a white paint made of an acrylic resin containing titanium dioxide or the like.

Moreover, a resin material in which a material itself has been adjusted to be white (for instance, white genestar manufactured by KURARAY CO., LTD.) or the like can also be molded to be used as the reflector frame 10. Furthermore, a member in which a metal material such as aluminum or a stainless steel has been processed can also be applied to the reflector frame 10. In such a case, a total reflection ratio of the reflector frame 10 is preferably 80% or higher, more preferably 90% or higher in a visible light region.

In particular, in the case in which the reflector frame 10 is molded by injection molding, a plurality of opening portions 12 can be easily formed at a time. In addition, since a mass production property is excellent, the reflector frame can be formed at a low cost.

In the case in which a portion corresponding to each opening portion 12 of the reflector frame 10 for a metal mold that is used in carrying out injection molding is formed in an insert die manner, as described later, even in the case in which a shape of an opening portion 12 is modified, a reflector frame 10 provided with an opening portion 12 of a different shape can be formed by only exchanging an insert die.

Moreover, an opening portion 12 is formed to be slightly larger than a formation area of the LED assembly 30 in such a manner that the outside of the LED assembly 30 can be covered. In addition, a cross sectional shape of the opening portion 12 has faces 14 inclined in such a manner that an opening diameter becomes smaller toward the LED assembly 30 as shown in FIG. 3(b). An inclination angle α of the inclined face 14 is larger than 90 degrees and is smaller than 120 degrees preferably.

In the case in which the reflector frame 10 in which such opening portions 12 have been formed is disposed on the light-emitting device mounting substrate 22 as shown in FIG. 4(b), each opening portion 12 is corresponded to each LED assembly 30.

Here, in the case in which the reflector frame 10 is disposed on the light-emitting device mounting substrate 22, the disposition is preferably carried out through an adhesive. Moreover, bonding wires (not shown) can be protected by burying a transparent sealing resin such as a silicone resin in the opening portion 12 of the reflector frame 10.

A method of burying a sealing resin in the opening portion 12 of the reflector frame 10 is not restricted in particular, and a potting with a dispenser can be adopted for instance. If necessary, a method of screen printing with a metal mask having an opening corresponding to the opening portion 12 can be suitably used for a satisfactory working efficiency.

According to the above configuration, an integrated flat light source device 40 can be obtained without a misalignment of a position.

Moreover, by forming the flat light source device 40 as described above, even in the case in which there is formed a flat light source device 40 of a wide range for a display device such as a liquid crystal display, it is not necessary to form or dispose many reflector frames 10, thereby facilitating a fabrication of the flat light source device 40. Consequently, a flat light source device can be easily fabricated at a low cost.

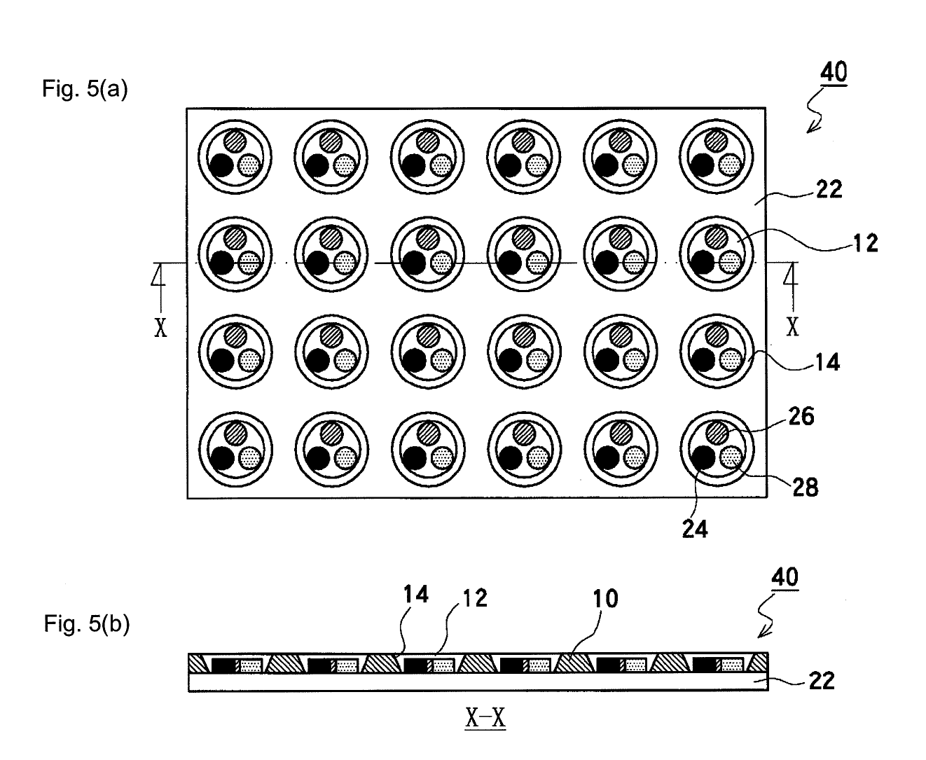

FIG. 5 shows a flat light source device 40 in which a reflector frame related to another embodiment according to the present invention is disposed.

Since the major elements of a flat light source device 40 shown in FIG. 5 are equivalent to those in the above embodiment shown in FIGS. 2 to 4, elements equivalent to those illustrated previously are numerically numbered similarly and the detailed descriptions of the equivalent elements are omitted.

In the flat light source device 40 shown in FIG. 5, a plurality of opening portions 12 formed in the reflector frame 10 is circular.

In the case in which the opening portions 12 are circular as described above, a light emitted from each of the LED chips 24, 26, and 28 can be effectively irradiated from any position as a white light.

In addition, since the opening portions 12 are circular, a metal mold for forming the reflector frame 10 can be further easily processed.

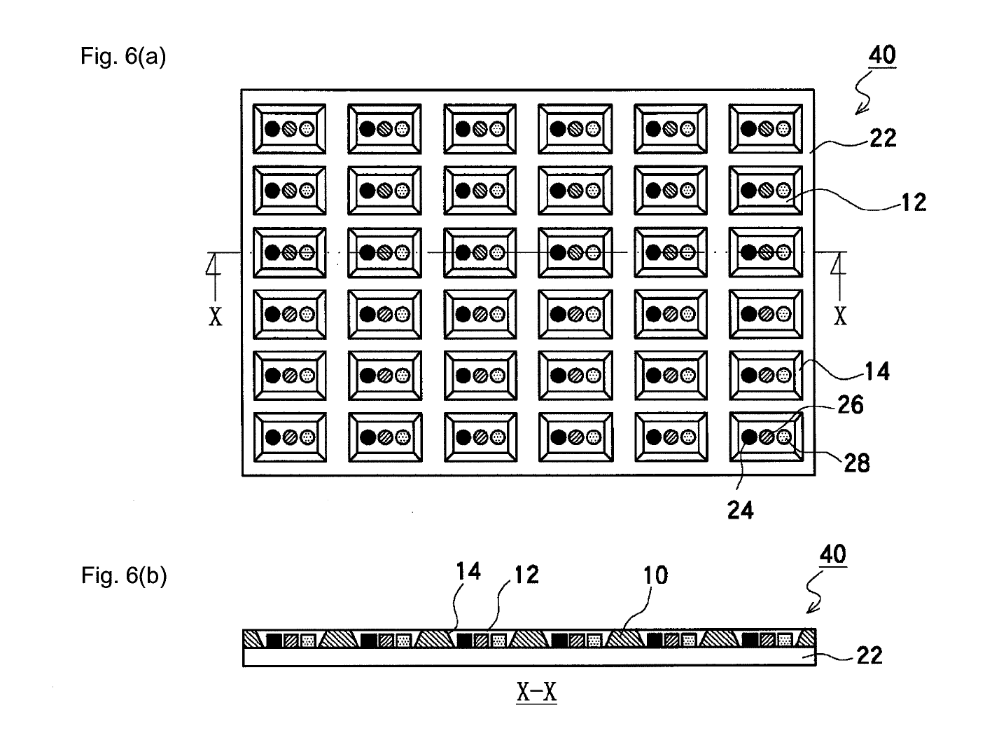

FIG. 6 shows a flat light source device 40 in which a reflector frame related to another embodiment according to the present invention is disposed.

Since the major elements of a flat light source device 40 provided with a reflector frame 10 shown in FIG. 6 are also equivalent to those in the above embodiment shown in FIGS. 2 to 4, elements equivalent to those illustrated previously are numerically numbered similarly and the detailed descriptions of the equivalent elements are omitted.

In the flat light source device 40 provided with the reflector frame 10 shown in FIG. 6, LED chips 24, 26, and 28 are disposed linearly in series on the upper face of a light-emitting device mounting substrate 22.

In the case in which the LED chips 24, 26, and 28 are disposed linearly in series as described above, since the LED chips 24, 26, and 28 can be densely disposed in a unit area without a futility, a sufficient luminance can be obtained.

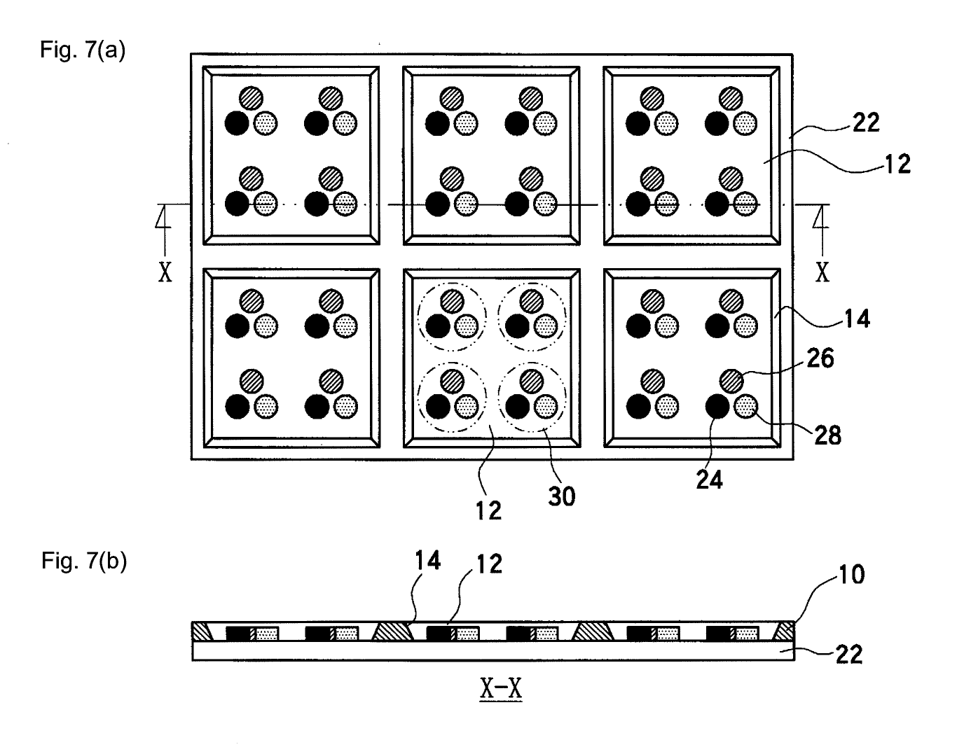

FIG. 7 shows a flat light source device 40 in which a reflector frame related to another embodiment according to the present invention is disposed.

In a flat light source device 40 shown in FIG. 7, elements equivalent to those illustrated previously are numerically numbered similarly and the detailed descriptions of the equivalent elements are omitted.

In the flat light source device 40 shown in FIG. 7, one opening portion 12 is formed corresponding to one group including a plurality of LED assemblies 30.

In the case in which one opening portion 12 is formed corresponding to one group including a plurality of LED assemblies 30 as described above, the LED chips 24, 26, and 28 can be densely disposed as compared with a flat light source device 40 in which one opening portion 12 is formed corresponding to one LED assembly 30, thereby obtaining a sufficient luminance.

While the preferred embodiments of the present invention have been described above, the present invention is not restricted to the embodiments.

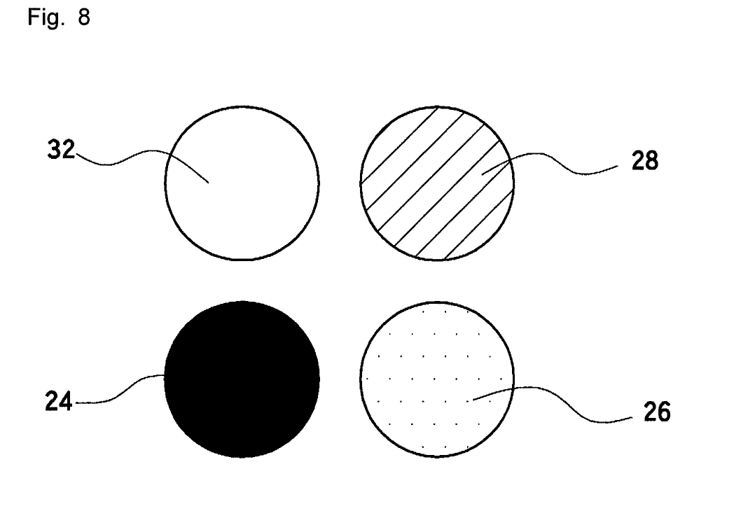

While a reflector frame, a flat light source device provided with the reflector frame, and a display device using the flat light source device related to the present invention were illustrated using the LED chip emitting a red light 24, the LED chip emitting a green light 26, and the LED chip emitting a blue light 28 as a light-emitting device, LED chips with four or more colors can also be used as shown in FIG. 8 for instance.

In the case in which four colors are used, an LED chip emitting an olive light 32 is preferably used as the fourth color for instance since it has a high color rendering index.

Moreover, it is not necessary to uniform the number of LED chips corresponding to one opening portion 12. For instance, the total four LED chips composed of two LED chips emitting a red light, one LED chip emitting a green light, and one LED chip emitting a blue light can also be corresponded to one opening portion 12. Such a combination of LED chips is not restricted. Furthermore, a light-emitting device is not restricted to an LED chip, and an LED lamp provided with a lens portion can also be used.

Furthermore, a white color light-emitting device that does not require mixing of colors can also be installed, and various changes, modifications, and functional additions can be thus made without departing from the scope of the present invention.

1. A reflector frame, which is disposed on a light-emitting device mounting substrate on which a plurality of light-emitting devices is disposed in an array pattern, comprising a plurality of opening portions corresponding to the disposed positions of the light-emitting devices.

2. A reflector frame as defined in claim 1, wherein a plurality of the light-emitting devices with different luminescent colors is disposed in the opening portion.

3. A reflector frame as defined in claim 2, wherein the light-emitting devices with different luminescent colors are configured by a combination of at least one light-emitting device with a luminescent color of red, at least one light-emitting device with green, and at least one light-emitting device with blue.

4. A reflector frame as defined in claim 1, wherein a light-emitting device with a luminescent color of white is disposed in the opening portion.

5. A reflector frame as defined in claim 1, wherein the opening portion is in an almost circular or rectangular shape.

6. A reflector frame as defined in claim 1, further comprising a reflecting face that spreads and opens toward the outside in the opening portion.

7. A reflector frame as defined in claim 1, wherein the light-emitting device is a light emitting diode (LED).

8. A reflector frame as defined in claim 7, wherein the light emitting diode (LED) is a light emitting diode (LED) chip.

9. A flat light source device, comprising a reflector frame as defined in claim 1 on the upper face of the light-emitting device mounting substrate on which a plurality of the light-emitting devices is disposed in an array pattern.

10. A flat light source device as defined in claim 9, further comprising a transparent sealing resin buried in the opening portion of the reflector frame.

11. A flat light source device as defined in claim 9, wherein the flat light source device is a back light for a display device.

12. A display device wherein a liquid crystal panel is disposed on the upper face of the flat light source device as defined in claim 9.

13. A manufacturing method of a flat light source device comprising the steps of:
disposing a plurality of light-emitting devices in an array pattern on a light-emitting device mounting substrate,
preparing a reflector frame provided with a plurality of opening portions corresponding to the disposed positions of the light emitting devices, and
disposing the reflector frame at the disposed position corresponding to the light-emitting devices on the light-emitting device mounting substrate.

14. A manufacturing method of a flat light source device as defined in claim 13, further comprising the step of burying a transparent sealing resin in the opening portion of the reflector frame.

15. A manufacturing method of a display device comprising the steps of:
preparing the flat light source device obtained by the manufacturing method as defined in claim 13, and
disposing a liquid crystal panel on the upper face of the flat light source device.
